(19) United States
(12) Patent Application Publication
(10) Pub. No.: US 2025/0097861 A1
(43) Pub. Date: Mar. 20, 2025

(54) TRANSMITTING A SIDELINK FEEDBACK MESSAGE ACCORDING TO A SIDELINK SLOT STRUCTURE

(71) Applicant: QUALCOMM Incorporated, San Diego, CA (US)

(72) Inventors: Chih-Hao LIU, San Diego, CA (US); Jing SUN, San Diego, CA (US); Xiaoxia ZHANG, San Diego, CA (US); Qingjiang TIAN, San Diego, CA (US)

(21) Appl. No.: 18/467,573

(22) Filed: Sep. 14, 2023

(51) Int. Cl. H04W 52/52; H04W 92/18

(52) U.S. Cl. CPC H04W 52/52; H04W 92/18

(57) ABSTRACT

Methods, systems, and devices for wireless communication are described. A user equipment (UE) may participate in sidelink communication using a sidelink slot structure that includes a set of periodic automatic gain control (AGC) candidate transmission time intervals (TTIs) that are common across a wireless network. The UE may monitor for a sidelink message during an interval in accordance with the set of common, periodic AGC TTIs, and the UE may transmit a sidelink feedback message in response to the sidelink message. The UE may transmit the sidelink feedback message over a set of resource blocks (RBs) of the sidelink slot structure if a format of the sidelink feedback message is associated with an uplink control channel format 0. Alternatively, the UE may transmit the sidelink feedback message over more than two symbols of the sidelink slot structure if the format is associated with an uplink control channel format 2.

### FIELD OF TECHNOLOGY

The following relates to wireless communication, including transmitting a sidelink feedback message according to a sidelink slot structure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may utilize different slot structures for data transmissions in different frequency ranges. Such slot structures may include data transmission time intervals (TTIs) in which the UE may transmit data of feedback, and one or more automatic gain control (AGC) TTIs, which may precede a set of data TTIs. A slot structure may include a configurable quantity of resource blocks (RBs) that may enable the UE to transmit data at a maximum transmit power. However, techniques for maintaining the full transmit power using a dynamic sidelink structure that includes multiple AGC symbols or slots may be improved.

### SUMMARY

The described techniques relate to improved methods, systems, devices, and apparatuses that support transmitting a sidelink feedback message according to a sidelink slot structure. For example, the described techniques provide for a format for transmitting a sidelink feedback message for a dynamic sidelink slot structure in frequency range (FR) 2-2. A first user equipment (UE) may participate in sidelink communication with a second UE using a sidelink slot structure. The sidelink slot structure may include a set of periodic automatic gain control (AGC) transmission time intervals (TTIs) (e.g., slots, symbols) that may be common across a wireless network. The first UE may monitor for a sidelink message during a monitoring interval that may be associated with the AGC TTIs in the slot sidelink slot format. For example, the UE may monitor for the sidelink message in one or more slots or symbols directly following an AGC TTI. In some examples, the UE may transmit a sidelink feedback message, where a format of the sidelink feedback message may be associated with an uplink control channel format and the sidelink slot structure. For example, the UE may transmit the sidelink feedback message over a set of resource blocks (RBs) of the sidelink slot structure if a format of the sidelink feedback message is associated with a physical uplink control channel (PUCCH) format 0. Alternatively, the UE may transmit the sidelink feedback message over more than two symbols of the sidelink slot structure if the format of the sidelink feedback message is associated with a PUCCH format 2.

A method for wireless communications by a UE is described. The method may include participating in sidelink communication in accordance with a sidelink slot structure used in a wireless network, where the sidelink slot structure includes a set of periodic AGC candidate TTIs that are common across the wireless network, monitoring for a sidelink message during a monitoring interval associated with the set of common and periodic AGC candidate TTIs in the sidelink slot structure, and transmitting a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

A UE for wireless communications is described. The UE may include one or more memories storing processor executable code, and one or more processors coupled with the one or more memories. The one or more processors may individually or collectively operable to execute the code to cause the UE to participate in sidelink communication in accordance with a sidelink slot structure used in a wireless network, where the sidelink slot structure includes a set of periodic AGC candidate TTIs that are common across the wireless network, monitor for a sidelink message during a monitoring interval associated with the set of common and periodic AGC candidate TTIs in the sidelink slot structure, and transmit a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

Another UE for wireless communications is described. The UE may include means for participating in sidelink communication in accordance with a sidelink slot structure used in a wireless network, where the sidelink slot structure includes a set of periodic AGC candidate TTIs that are common across the wireless network, means for monitoring for a sidelink message during a monitoring interval associated with the set of common and periodic AGC candidate TTIs in the sidelink slot structure, and means for transmitting a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

A non-transitory computer-readable medium storing code for wireless communications is described. The code may include instructions executable by a processor to participate in sidelink communication in accordance with a sidelink slot structure used in a wireless network, where the sidelink slot structure includes a set of periodic AGC candidate TTIs that are common across the wireless network, monitor for a sidelink message during a monitoring interval associated with the set of common and periodic AGC candidate TTIs in the sidelink slot structure, and transmit a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

### BRIEF DESCRIPTION OF THE DRAWINGS

FIG. 1 shows an example of a wireless communications system that supports transmitting a sidelink feedback message according to a sidelink slot structure in accordance with one or more aspects of the present disclosure.

FIG. 2 shows an example of a wireless communications system that supports transmitting a sidelink feedback message according to a sidelink slot structure in accordance with one or more aspects of the present disclosure.

FIG. 3 shows an example of a sidelink slot structure that supports transmitting a sidelink feedback message according to a sidelink slot structure in accordance with one or more aspects of the present disclosure.

FIG. 4 shows an example of a process flow that supports transmitting a sidelink feedback message according to a sidelink slot structure in accordance with one or more aspects of the present disclosure.

FIGS. 5 and 6 show block diagrams of devices that support transmitting a sidelink feedback message according to a sidelink slot structure in accordance with one or more aspects of the present disclosure.

FIG. 7 shows a block diagram of a communications manager that supports transmitting a sidelink feedback message according to a sidelink slot structure in accordance with one or more aspects of the present disclosure.

FIG. 8 shows a diagram of a system including a device that supports transmitting a sidelink feedback message according to a sidelink slot structure in accordance with one or more aspects of the present disclosure.

FIGS. 9 through 12 show flowcharts illustrating methods that support transmitting a sidelink feedback message according to a sidelink slot structure in accordance with one or more aspects of the present disclosure.

### DETAILED DESCRIPTION

Some user equipment (UE) may utilize different slot structures for communications depending on the type of data to be transmitted. A wireless communications system (e.g., New Radio (NR)) may support scalable numerology (15, 30, 60, 120 kHz, etc.) and variable slot durations (0.5, 0.25, 0.125 ms, etc.). Each slot structure may contain downlink control information (DCI), downlink data, uplink data, uplink control information, timing gaps (e.g., guard periods), or any combination thereof. In some cases, the traffic conditions for a UE 115 may include traffic bursts (e.g., downlink-heavy or uplink-heavy traffic at certain times or over certain frequencies) or the channel conditions for the UE 115 may change over time (e.g., from the edge of the cell to the center of the cell). Additionally, a set of UEs 115 that are scheduled at a cell may change over time, and the slot structure for downlink, uplink, or sidelink (e.g., the usage of physical sidelink control channel (PSCCH) formats and physical sidelink shared channel (PSSCH) formats) may change over time.

To account for the different data types and channel conditions, the UE supporting sidelink communications (e.g., a sidelink UE) may communicate using a particular sidelink slot structure for a specific frequency range (FR). Such sidelink slot structures may be dynamic so that the UE may change the sidelink slot structure it uses based on changing data or channel conditions. For example, the UE may use a first sidelink slot structure while operating in a first FR. If the UE experiences a change in traffic conditions in the first FR, the sidelink slot structure may dynamically change to better handle the traffic.

In an example, for FR2-2, the sidelink slot structure may include a set of periodic automatic gain control (AGC) candidate slots or symbols, where each data transmission (e.g., a PSCCH or PSSCH transmission) may occur over one or more slots or symbols after an AGC slot or symbol in the sidelink slot structure. In addition, the sidelink UE may transmit feedback (e.g., a physical sidelink feedback channel (PFSCH) transmission) in one or more slots or symbols after an AGC slot or symbol in the sidelink slot structure. Each AGC slot or symbol may enable the UE to monitor and/or change the gain of a received signal such that the signal strength falls within a range the UE is capable of processing. For example, an AGC measurement may include received signal strength indicator (RSSI) measurements, amplifier tuning (e.g., low-noise amplifier (LNA) tuning), and RSSI measurement refinement. In some examples, operating in a relatively higher FR (e.g., FR2-1 or FR2-2) with a relatively higher subcarrier spacing (SCS) (e.g., 120 kHz) may result in shorter symbol durations, and as such, the UE 115 may be unable to complete AGC using a single AGC symbol.

In some examples, a quantity of AGC slots or symbols (also referred to as transmission time intervals (TTIs)) in a sidelink slot structure and quantities and locations of the data TTIs may be based on or associated with different numerologies. For example, for an SCS of 120 kHz, the sidelink slot structure may support a four-symbol AGC candidate TTI, a data TTI (e.g., a PSSCH TTI, a PSCCH TTI), and a one-symbol gap in a last PSSCH slot. In addition, the sidelink slot structure may support a four-symbol AGC candidate TTI, a half-symbol PSFCH TTI (i.e., a half-symbol PSFCH symbol), and one or more gaps (e.g., one or more gap symbols). In some other examples, for an SCS of 480 kHz, the sidelink slot structure may support one AGC candidate TTI (e.g., one AGC candidate slot), multiple data TTIs, and at least a four-symbol gap (e.g., a transmit/receive gap) in the last PSSCH slot. In addition, the sidelink slot structure may support one AGC candidate TTI (e.g., one AGC candidate slot) followed by a PSFCH TTI (e.g., a PSFCH slot) and at least a four-symbol gap.

In some aspects, for example in FR2-2 Uu communications (e.g., uplink and downlink communications between a UE and a network entity), PUCCH formats 0, 1, 3, and 4 may be enhanced to occupy a configurable quantity of RBs such that the UE may transmit a PUCCH at a maximum power under an effective isotropic radiated power (EIRP) limit. For sidelink communications, however, current techniques may lack support for DFT-precoded PUCCH formats (e.g., PUCCH formats 3 and 4). In addition, the UEs may support multi-bit formats (e.g., PUCCH format 2) to carry a HARQ codebook, however the PUCCH format 2 may be limited to occupying up to two symbols, thus making a PSFCH slot inefficient in the sidelink slot structure. That is, a PUCCH format 2-based PSFCH may not be allowed to span more than two symbols. In addition, a PUCCH format 0-based PSFCH may not be allowed to occupy more than one RB, which may result in coverage issues under an EIRP limit. Thus, the wireless communications system may support enhancements to PSFCH waveforms for sidelink communications in FR2-2 to support a full transmit power of the UEs and to fit in the sidelink slot structure, which may include multiple AGC symbols or slots (AGC candidate TTIs).

For uplink and downlink Uu communications (e.g., uplink and downlink communications between a UE and a network entity) in FR2-2, PUCCH formats 0, 1, 3, and 4 may be enhanced to occupy a configurable quantity of resource blocks (RBs) such that the UE may transmit a PUCCH at a maximum power. In sidelink communications, however, the sidelink slot structure including periodic AGC slots or symbols may be limited, and thus, may fail to support the full transmit power of a UE and may reduce utilization efficiency of time and frequency resources (e.g., if a physical sidelink shared channel (PSFCH) uses half of the available symbols, the remaining symbols may be unused). For example, PUCCH formats 3 and 4 may be unsupported for sidelink communications, and other PUCCH formats (e.g., PUCCH format 2) may support a limited quantity of slots or symbols, which may result in inefficiencies in the sidelink slot structure for FR2-2 (particularly regarding a PSFCH slot or symbol). That is, a PUCCH format 2-based PSFCH may not be allowed to span more than two symbols. In addition, a PUCCH format 0-based PSFCH may not be allowed to occupy more than one RB. As such, PSFCH transmissions may be limited for a sidelink slot structure in FR2-2.

The techniques described herein support a format for transmitting a sidelink feedback message for a dynamic sidelink slot structure in FR2-2. A first UE may participate in sidelink communication with a second UE using a sidelink slot structure that includes a set of periodic AGC transmission time intervals (TTIs) (e.g., slots, symbols) that may be common across a wireless network. The first UE may monitor for a sidelink message (e.g., PSSCH, PSCCH, or other data) during a monitoring interval associated with the AGC TTIs in the slot sidelink slot format. For example, the UE may monitor for the sidelink message in one or more slots or symbols directly following an AGC TTI. In some examples, the UE may transmit a sidelink feedback message (e.g., a PSFCH), where a format of the sidelink feedback message may be associated with an uplink control channel format and the sidelink slot structure. For example, the UE may transmit the sidelink feedback message over a set of RBs of the sidelink slot structure if a format of the sidelink feedback message is associated with a PUCCH format 0. Alternatively, the UE may transmit the sidelink feedback message over more than two symbols of the sidelink slot structure if the format of the sidelink feedback message is associated with a PUCCH format 2.

In some aspects, the UE may transmit the PSFCH over the set of RBs through transmission of one or more PSFCH repetitions or through transmission of a sequence, where a length of the sequence is associated with the set of RBs. Alternatively, the UE may transmit the PSFCH over the set of RBs through transmission of one or more PSFCH repetitions over the set of RBs and over multiple symbols. In such cases, the UE may apply a time-domain orthogonal cover code (TD-OCC) to the transmission of the PSFCH repetitions. In some implementations, the UE may receive a control message before transmission of the PSFCH, where the control message may, on a per-resource pool basis, indicate a quantity of RBs and a starting RB of the set of RBs over which the transmission of the PSFCH is to start. In some examples, the control message may indicate a bitmap corresponding to the set of RBs.

In some aspects, the UE may support a PUCCH format 2-based PSFCH transmission, where the UE may transmit the PSFCH over more than two symbols in accordance with mapping the more than two symbols to a quantity of RBs of the sidelink slot structure. Additionally, or alternatively, the UE may repeat the PSFCH on a per-quantity of symbol basis and apply a TD-OCC to the repetition. In such cases, the UE may multiplex the PSFCH repetition based on CDM, the CDM based on an applied TD-OCC and an applied frequency domain-OCC (FD-OCC).

Particular aspects of the subject matter described in this disclosure can be implemented to realize one or more of the following potential advantages. In some implementations, by supporting a format for transmitting a sidelink feedback message for a dynamic sidelink slot structure in FR2-2, the UE may improve and broaden coverage, improve power consumption, and increase signaling throughput. For example, by transmitting a PSFCH using a dynamic slot structure through transmission of a set of PSFCH repetitions, the UE may support a multiplexing capacity of the UE, thus increasing signaling throughput and optimizing power consumption. In addition, by transmitting the PSFCH over more than two symbols in accordance with mapping the more than two symbols to a quantity of RBs of the sidelink slot structure, the UE may improve efficiency of slot structure, which may enable the UE to transmit at a maximum transmission power.

Aspects of the disclosure are initially described in the context of wireless communications systems. Aspects of the disclosure are then described in the context of sidelink slot structures and process flows. Aspects of the disclosure are further illustrated by and described with reference to apparatus diagrams, system diagrams, and flowcharts that relate to transmitting a sidelink feedback message according to a sidelink slot structure.

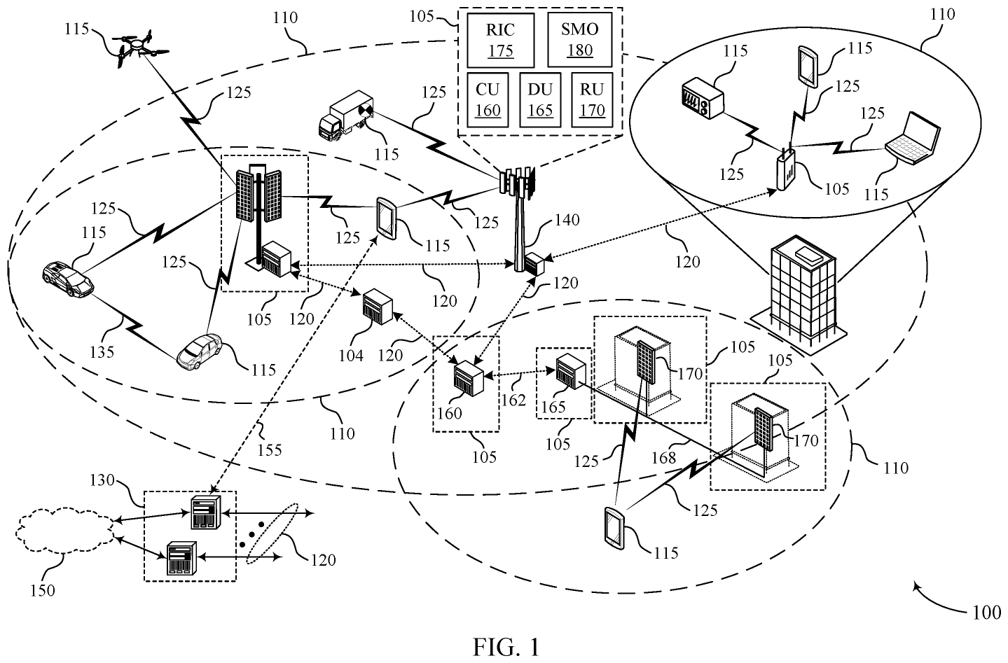

FIG. 1 shows an example of a wireless communications system 100 that supports transmitting a sidelink feedback message according to a sidelink slot structure in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support transmitting a sidelink feedback message according to a sidelink slot structure as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing (SCS) may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include an SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., Nf) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support a format for transmitting a sidelink feedback message for a dynamic sidelink slot structure in FR 2-2. A first UE 115 may participate in sidelink communication with a second UE 115 using a sidelink slot structure. The sidelink slot structure may include a set of periodic AGC TTIs (e.g., slots, symbols) that may be common across a wireless network. The first UE 115 may monitor for a sidelink message (e.g., PSSCH, PSCCH) during a monitoring interval associated with the AGC TTIs in the slot sidelink slot format. For example, the UE 115 may monitor for the sidelink message in one or more slots or symbols directly following an AGC TTI. In some examples, the UE 115 may transmit a sidelink feedback message (e.g., PSFCH), where a format of the sidelink feedback message may be associated with an uplink control channel format and the sidelink slot structure. For example, the UE 115 may transmit the sidelink feedback message over a set of RBs of the sidelink slot structure if a format of the sidelink feedback message is associated with a PUCCH format 0. Alternatively, the UE 115 may transmit the sidelink feedback message over more than two symbols of the sidelink slot structure if the format of the sidelink feedback message is associated with a PUCCH format 2.

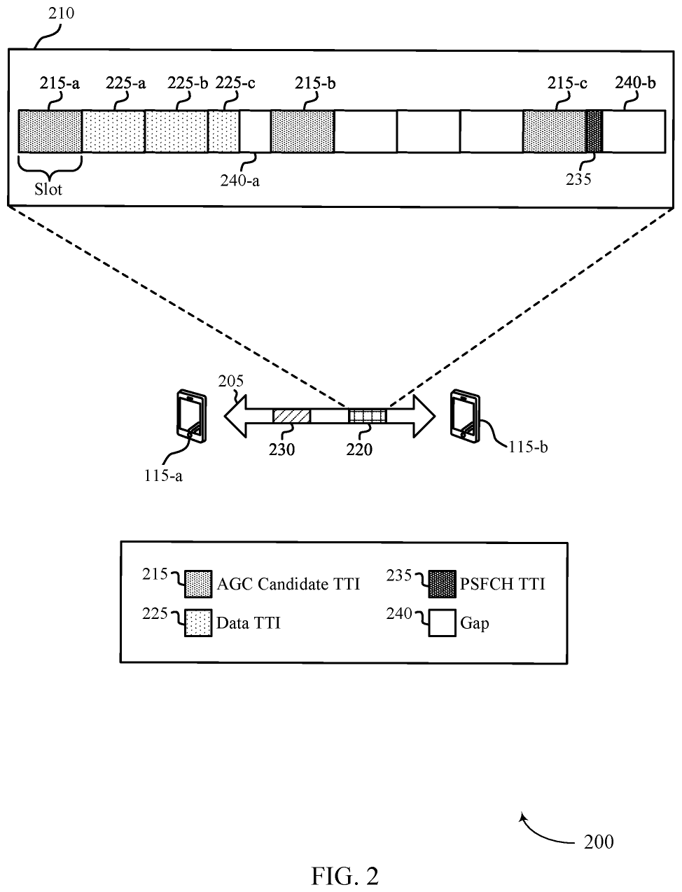

FIG. 2 shows an example of a wireless communications system 200 that supports transmitting a sidelink feedback message according to a sidelink slot structure in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a UE 115-b, which may be examples of UEs 115 described herein. The UEs 115 may support a format for transmitting a sidelink feedback message (e.g., a PSFCH) in accordance with a dynamic sidelink slot structure in FR 2-2.

The wireless communications system 200 may support communications between the UEs 115 via a communication link 205 (e.g., a sidelink) which may be an example of a communication link 125 described herein with reference to FIG. 1. The UE 115-a may participate in sidelink communication with the UE 115-b (e.g., via the communication link 205) in accordance with a sidelink slot structure 210 used in the wireless communications system 200 (e.g., a wireless network). The sidelink slot structure 210 may include a set of AGC candidate TTIs 215 that may be common across the wireless communications system 200. In addition, the sidelink slot structure 210 may include some quantity of data TTIs 225, PSFCH TTIs 235, and gaps 240 (e.g., gap symbols). For example, the sidelink slot structure 210 may include an AGC candidate TTI 215-a, an AGC candidate TTI 215-b, and an AGC candidate TTI 215-c, which may be examples of AGC candidate symbols or slots. In the example of FIG. 2, the AGC candidate TTIs 215 may have a period of four slots. In addition, the data TTIs 225 may include PSSCH slots or symbols, PSCCH slots or symbols, or a combination thereof, and the sidelink slot structure 210 may include a gap 240-a and a gap 240-b, which may include at least four symbols. Additional gaps 240 in the sidelink slot structure 210 may be used for communicating other types data, or may be empty.

In some examples, a quantity of AGC candidate TTIs 215 in the sidelink slot structure 210 and quantities and locations of the data TTIs 225 may be based on or associated with different numerologies. For example, for an SCS of 120 kHz, the sidelink slot structure 210 may support a four-symbol AGC candidate TTI 215, a data TTI 225 (e.g., a PSSCH TTI, a PSCCH TTI), and a one-symbol gap 240 in a last PSSCH slot. In addition, the sidelink slot structure 210 may support a four-symbol AGC candidate TTI 215, a half-symbol PSFCH TTI 235 (i.e., a half-symbol PSFCH symbol), and one or more gaps 240 (e.g., one or more gap symbols). In some other examples, for an SCS of 480 kHz, the sidelink slot structure 210 may support one AGC candidate TTI 215 (e.g., one AGC candidate slot), multiple data TTIs 225, and at least a four-symbol gap 240 (e.g., a transmit/receive gap) in the last PSSCH slot. In addition, the sidelink slot structure may support one AGC candidate TTI 215 (e.g., one AGC candidate slot) followed by a PSFCH TTI 235 (e.g., a PSFCH slot) and at least a four-symbol gap 240.

In FR2-2 Uu communications (e.g., uplink and downlink communications between a UE 115 and a network entity 105), PUCCH formats 0, 1, 3, and 4 may be enhanced to occupy a configurable quantity of RBs such that the UE 115 may transmit a PUCCH at a maximum power under an effective isotropic radiated power (EIRP) limit. For sidelink communications, however, current techniques may lack support for DFT-precoded PUCCH formats (e.g., PUCCH formats 3 and 4). In addition, the UEs 115 may support multi-bit formats (e.g., PUCCH format 2) to carry a HARQ codebook, however the PUCCH format 2 may be limited to occupying up to two symbols, thus making a PSFCH slot inefficient in the sidelink slot structure 210. That is, a PUCCH format 2-based PSFCH may not be allowed to span more than two symbols. In addition, a PUCCH format 0-based PSFCH may not be allowed to occupy more than one RB, which may result in coverage issues under an EIRP limit. Thus, the wireless communications system 200 may support enhancements to PSFCH waveforms for sidelink communications in FR2-2 to support a full transmit power of the UEs 115 and to fit in the sidelink slot structure 210, which may include multiple AGC symbols or slots (AGC candidate TTIs 215).

In accordance with the sidelink slot structure 210, a UE 115 may transmit either a PSSCH, a PSCCH, or a PSFCH (including AGC symbols or slots) starting from the AGC candidate TTIs 215. That is, a sidelink message or sidelink feedback message transmission may occur over one or more TTIs that follow an AGC candidate TTI 215. For example, if the AGC candidate TTIs 215 have a period of four slots, the AGC candidate TTI 215-a may be followed by a data TTI 225-a (e.g., a PSCCH slot, a PSSCH slot), a data TTI 225-b (e.g., a PSSCH slot) and a data TTI 225-c (e.g., a PSSCH half-slot), and a gap 240-a (e.g., a half-slot gap). The gap 240-a may be followed by the AGC candidate TTI 215-b, which may be followed symbols for additional data transmissions, and so on. If a UE 115 has additional data to transmit before the AGC candidate TTI 215-b (e.g., more than three slots worth of data), the UE 115 may override the AGC candidate TTI 215-b and instead transmit a PSSCH or a PSCCH in that TTI.

In some examples, the UE 115-a may monitor for a sidelink message 220 (e.g., PSSCH, PSCCH) during a monitoring interval associated with the AGC candidate TTIs 215 in the sidelink slot structure 210. For example, the UE 115-a may monitor for the sidelink message 220 during the data TTI 225-a, the data TTI 225-b, the data TTI 225-c, or any other data TTIs 225 that follow the AGC candidate TTI 215-a in the sidelink slot structure 210. In accordance with monitoring for the sidelink message 220, the UE 115-a may transmit a sidelink feedback message 230 (e.g., an ACK/NACK PSFCH). In some examples, a format of the sidelink feedback message 230 may be associated with the PUCCH format 0, in which case the UE 115-a may transmit the sidelink feedback message 230 over a set of multiple RBs of the sidelink slot structure 210. The set of multiple RBs may include a pre-configurable quantity of RBs (e.g., M_{RB}). Alternatively, the format of the sidelink feedback message 230 may be associated with the PUCCH format 2, in which case the UE 115-a may transmit the sidelink feedback message 230 over more than two symbols of the sidelink slot structure. In this way, the UEs 115 may support PUCCH 0 and PUCCH 2-based PSFCH transmissions in accordance with the sidelink slot structure 210.

In some examples of FR2-2 Uu communications, the PUCCH format 0 may be configurable to occupy up to 16 RBs. For sidelink communications as described herein, the sidelink slot structure 210 may allow a PUCCH format 0-based PSFCH to occupy a pre-configurable quantity of RBs (e.g., M_{RB}) using repetition or a long-base sequence. For example, to enable a PSFCH transmission to occupy more than one RB, the UE 115-a may repeat the PSFCH TTI 235 multiple times in the sidelink slot structure 210 and apply cyclic shift ramping to reduce a peak-to-average-power ratio (PAPR). To apply the cyclic shift ramping, the UE 115-a may introduce different cyclic shift offsets for different RBs in a PSFCH resource (e.g., the PSFCH TTI 235). In this way, the UE 115-a may transmit the sidelink feedback message 230 over the set of multiple RBs through transmission of a set of multiple repetitions of the sidelink feedback message 230, and the UE 115-a may apply a cyclic shift offset for each respective RB of the set of multiple RBs.

Alternatively, to allow a PUCCH format 0-based PSFCH to occupy a pre-configurable quantity of RBs (e.g., M_{RB}), the UE 115-a may increase a length of a base sequence associated with the PSFCH, for example from a length of 12 to a length of 12M_{RB}. In some examples, the length of a type of the sequence may be associated with or based on the length of the transmitted sequence. For example, if the length 12M_{RB}≥36, the sequence may be from a Zadoff-Chu sequence. If the length 12M_{RB}<36, the sequence may be from a computer-generated sequence. In this way, the UE 115-a may transmit the sidelink feedback message 230 over the set of multiple RBs through transmission of a sequence (e.g., a Zadoff-Chu sequence, a computer-generated sequence) whose length is associated with (or based on) a quantity of the set of multiple RBs.

In some cases, as the quantity of RBs that the PUCCH format 0-based PSFCH occupies increases, a multiplexing capacity of the UE 115-a for groupcast option 2 may be limited. That is, in sidelink communication, if the quantity of RBs is increased such that each sidelink feedback message 230 (e.g., each ACK/NACK) occupies one RB, the capacity of the PUCCH format 0-based PSFCH (e.g., the ACK/NACK carrying channel) may be reduced. Thus, to improve the multiplexing capacity of the UE 115-a when M_{RB} is greater than some preconfigured threshold, the UE 115-a may repeat M_{RB} contiguous RBs for a PUCCH format 0-based PSFCH in multiple symbols in the time-domain, and apply a time-domain orthogonal cover code (TD-OCC). In some examples, different UEs 115 may apply different TD-OCC sequences for different symbols to enable more UE multiplexing. As such, the UE 115-a may transmit the sidelink feedback message 230 over the set of multiple RBs through transmission of one or more repetitions of the sidelink feedback message 230 over the set of multiple RBs and over multiple symbols (e.g., PSFCH TTIs 235) of the sidelink slot structure 210. In addition, the UE 115-a may apply a TD-OCC to the transmission of the one or more repetitions of the sidelink feedback message 230 in accordance with a quantity of the set of multiple RBs (e.g., M_{RB}) exceeding a threshold. In accordance with applying the TD-OCC, the UE 115-a may multiplex the sidelink feedback message 230 with additional sidelink feedback messages.

A sidelink transmitter (e.g., the UE 115-a or the UE 115-b) may indicate the quantity of RBs for transmission of the one or more repetitions of the sidelink feedback message 230. In some cases, the UE 115-a may receive an RRC configuration message the set of multiple RBs over which to transmit the PSFCH repetitions. In such cases, the UE 115-a may exchange messages and negotiate the configuration with the UE 115-b. Alternatively, a network entity 105 may configure the sidelink UEs 115 in the wireless communications system 200 (including the UE 115-a and the UE 115-b) with particular quantities of RBs and PSFCH symbols based on different use cases.

In some sidelink scenarios, because a UE 115 may configure a contiguous quantity of RBs for one ACK/NACK message, the UE 115 may configure the quantity of RBs for the PSFCH transmissions and a starting RB of the PSFCH per resource pool. For example, the UE 115-a may receive a control message (e.g., an RRC configuration message) in advance of transmission of the sidelink feedback message 230 over the set of multiple RBs. The control message may indicate, on a per-resource pool basis, a quantity of the set of multiple RBs and a starting RB of the set of multiple RBs over which the UE 115-a may start the transmission of the sidelink feedback message 230. In some examples, the control message (e.g., an RRC configuration message) may indicate a frequency grid corresponding to the set of M_{RB} RBs for the PSFCH transmission.

Additionally, or alternatively, a UE 115 may use a bitmap sl-PSFCH-RB-set to indicate single RB PSFCH resources in a resource pool. For example, the M_{RB} continuous RBs of the set of multiple RBs may be indicated in a bitmap, where RBs (e.g., physical RBs (PRBs)) may be grouped as one PSFCH resource starting from a lowest RB in the resource pool. In some cases, one bit in the bitmap may indicate on of the M_{RB} RBs for the PSFCH transmission, or the UEs 115 may reuse the bitmap sl-PSFCH-RB-set and allow M_{RB} contiguous bits to be set for the M_{RB} RBs. As such, the UE 115-a may receive a bitmap (e.g., via the control message) that indicates the set of multiple RBs, where each bit of the bitmap may indicate a corresponding RB of the set of multiple RBs.

In Uu communications, PUCCH format 2 may be configured to occupy up to 16 RBs, which may sufficiently address a power limit. However, the PUCCH format 2 may occupy one or two symbols in the time domain, which may make the use of a PUCCH format 2-based PSFCH slot inefficient in the sidelink slot structure 210. For example, the PSFCH may need to carry a large HARQ codebook for a super-slot (e.g., multiple contiguous slots over which feedback may be transmitted), or the PSFCH slot may need to carry ACK/NACK messages from a large quantity of receivers (e.g., groupcast option 2 receivers), such that a PSFCH multiplexing capacity of the UEs 115 may be limited.

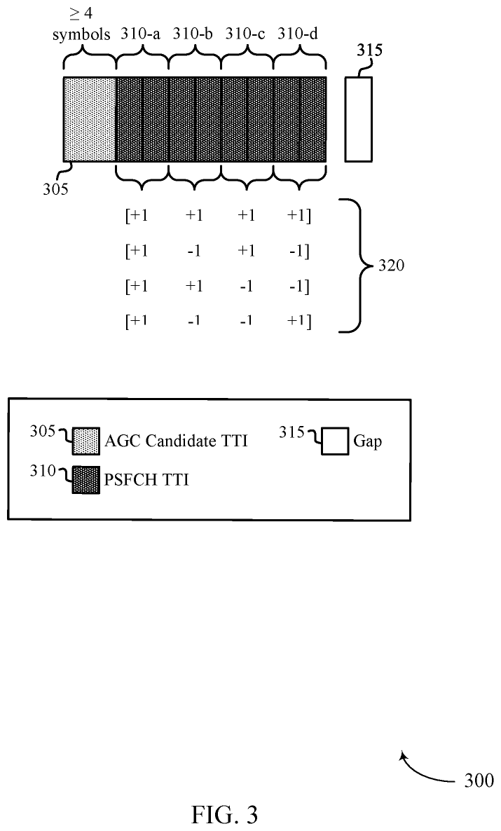

To address these limitations, the sidelink feedback message 230 may be a multi-symbol, PUCCH format 2-PSFCH, and the UE 115-a may transmit the sidelink feedback message 230 over more than two symbols of the sidelink slot structure 210. A quantity of the more than two symbols may be pre-configured, and the UE 115-a may map the symbols (after FDD-OCC spreading, if configured), to a pre-configured quantity of RBs and symbols (e.g., first in the frequency domain, and later in the time domain). That is, the UE 115-a may transmit the sidelink feedback message 230 over the more than two symbols through application of a mapping of the more than two symbols to a quantity of RBs of the sidelink slot structure 210. In addition, the UE 115-a may apply a frequency-domain orthogonal cover code (FD-OCC) to transmission of the sidelink feedback message 230 over the more than two symbols of the sidelink slot structure. Additional techniques for increasing a multiplexing capacity of the UE 115-a in accordance with a PUCCH format 2-based PSFCH are described herein with reference to FIG. 3.

FIG. 3 shows an example of a sidelink slot structure 300 that supports transmitting a sidelink feedback message according to a sidelink slot structure in accordance with one or more aspects of the present disclosure. In some examples, the sidelink slot structure 300 may implement aspects of the wireless communications systems 100 and 200 or may be implemented by aspects of the wireless communications systems 100 and 200. For example, the sidelink slot structure 300 may support a PUCCH format 2-based PSFCH, which may increase a multiplexing capacity of a UE 115.

As described herein with reference to FIG. 2, two or more UEs 115 may participate in sidelink communication in accordance with a sidelink slot structure, such as the sidelink slot structure 300, used in a wireless network. The sidelink slot structure 300 may include a set of periodic AGC candidate TTIs 305 (e.g., AGC slots or symbols) that may be common across the wireless network. For example, the sidelink slot structure 300 may include the AGC candidate TTI 305, which may include four or more symbols. The sidelink slot structure 300 may additionally include data TTIs (e.g., for transmitting PSSCHs and PSCCHs), PSFCH TTIs 310, one or more gap symbols 315, or a combination thereof. A UE 115 may monitor for a sidelink feedback message (e.g., PSCCH, PSSCH) in a monitoring interval associated with the AGC candidate TTIs 305 of the sidelink slot structure 300.

In accordance with the monitoring, the UE 115 may transmit a sidelink feedback message (e.g., a PSFCH). In the example of FIG. 3, a format of the sidelink feedback message may be associated with a PUCCH format 2, and the UE 115 may transmit the sidelink feedback message over more than two symbols of the sidelink slot structure 300. The symbols may be represented as PSFCH TTIs 310.

In some cases, the UE 115 may repeat a first quantity of symbols (e.g., X) of a PUCCH format 2-based PSFCH a second quantity of times (e.g., Y) in the time domain and apply a TD-OCC 320. That is, the UE 115 may transmit the sidelink feedback message over more than two symbols (e.g., PSFCH TTIs 310 following the AGC candidate TTI 305) through az on a per-quantity of symbol basis. In addition, the UE 115 may apply a TD-OCC 320 to the repetition of the sidelink feedback message. In the example of FIG. 3, the UE 115 may repeat a two-symbol PSFCH TTI 310 four times in the sidelink slot structure 300 (e.g., X=2, Y=4), including a two-symbol PSFCH TTI 310-a, a two-symbol PSFCH TTI 310-b, a two-symbol PSFCH TTI 310-c, and a two-symbol PSFCH TTI 310-d. Thus, the sidelink slot structure 300 may include eight symbols over which the UE 115 may transmit a sidelink feedback message. In addition, the UE 115 may apply four TD-OCCs 320, which may increase an occupancy of the PSFCH TTIs 310 by four times, thus increasing the efficiency of that PSFCH TTI 310. For example, the TD-OCC 320 may include sequences [+1+1+1+1], [+1−1+1−1], [+1+1−1−1], and [+1−1−1+1].

In some cases, the quantity of PSFCHs that the UE 115 may code division multiplex (CDM) may be of an order of an FD-OCC and the order of the TD-OCC 320 that are applied to the repetitions of the sidelink feedback message. That is, the UE 115 may multiplex the repetition of the sidelink feedback message in accordance with CDM, where the CDM is in accordance with an order of an FD-OCC applied to the repetition of the sidelink feedback message and an order of the TD-OCC 320 applied to the repetition of the sidelink feedback message over the PSFCH TTIs 310. For example, if the UE 115 applies the TD-OCC 320 and an FD-OCC-4 (e.g., a TD-OCC and an FDD-OCC on the order of four) to the two-symbol PSFCH TTIs 310 and repeats the two-symbol PSFCH TTIs 310 four times, the sidelink slot structure 300 may support multiplexing of up to 16 UEs, and the sidelink feedback message may occupy eight symbols in a PSFCH slot.

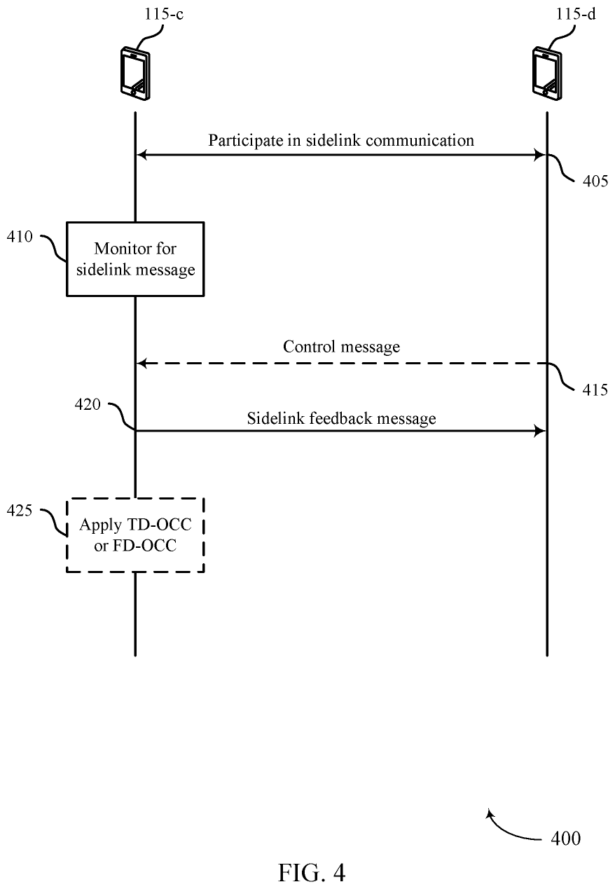

FIG. 4 shows an example of a process flow 400 that supports transmitting a sidelink feedback message according to a sidelink slot structure in accordance with one or more aspects of the present disclosure. The process flow 400 may implement aspects of wireless communications systems 100 and 200 and the sidelink slot structure 300, or may be implemented by aspects of the wireless communications system 100 and 200 and sidelink slot structure 300. For example, the process flow 400 may illustrate operations between a UE 115-c and a UE 115-d which may be examples of corresponding devices described herein. In the following description of the process flow 400, the operations between the UE 115-c and the UE 115-d may be transmitted in a different order than the example order shown, or the operations performed by the UE 115-c and the UE 115-d may be performed in different orders or at different times. Some operations may also be omitted from the process flow 400, and other operations may be added to the process flow 400.

At 405, the UE 115-c may participate in sidelink communication with the UE 115-d in accordance with a sidelink slot structure used in a wireless network, where the sidelink slot structure includes a set of periodic AGC candidate TTIs (e.g., slots, symbols) that are common across the wireless network. The sidelink slot structure may be configured such that resources (e.g., slots, symbols, TTIs) for sidelink message transmissions and for sidelink feedback message transmissions may follow an AGC candidate TTI.

At 410, the UE 115-c may monitor for a sidelink message (e.g., PSSCH, PSCCH) during a monitoring interval associated with the set of common and periodic AGC candidate TTIs in the sidelink slot structure. For example, the monitoring interval may occur across one or more symbols following an AGC candidate TTI of the set of common and periodic AGC candidate TTIs.

At 415, the UE 115-c may receive, from the UE 115-d, a control message (e.g., an RRC message) in advance of transmission of a sidelink feedback message over a set of multiple RBs, where the control message indicates, on a per resource pool basis, a quantity of the set of multiple RBs and a starting RB of the set of multiple RBs over which the transmission of the sidelink feedback message is to start. In some cases, the control message may include a bitmap that indicates the set of multiple RBs, where each bit of the bitmap may indicate a corresponding RB of the set of multiple RBs.

At 420, the UE 115-c may transmit, to the UE 115-d, a sidelink feedback message (e.g., a PSFCH) in accordance with the monitoring, where a format of the sidelink feedback message is associated with a PUCCH format 0 and the sidelink feedback message is transmitted over a set of multiple RBs of the sidelink slot structure, or where the format is associated with a PUCCH format 2 and the sidelink feedback message is transmitted over more than two symbols of the sidelink slot structure. For example, if the sidelink feedback message is a PUCCH format 0-PSFCH, the UE 115-c may transmit multiple repetitions of the sidelink feedback message over the set of multiple RBs.

At 425, if the sidelink feedback message is a PUCCH format 0-PSFCH, the UE 115-c may applying a TD-OCC to the transmission of one or more repetitions of the sidelink feedback message in accordance with a quantity of the set of multiple RBs exceeding a threshold. In some other examples, the sidelink feedback message is a PUCCH format 2-PSFCH, the UE 115-c may apply an FD-OCC to transmission of the sidelink feedback message over the more than two symbols of the sidelink slot structure or apply a TD-FDD to a repetition of the sidelink feedback message. In some examples, the UE 115-c may multiplex the sidelink feedback message with additional sidelink feedback messages in accordance with application of a TD-OCC, an FD-OCC, or both to the sidelink feedback message.

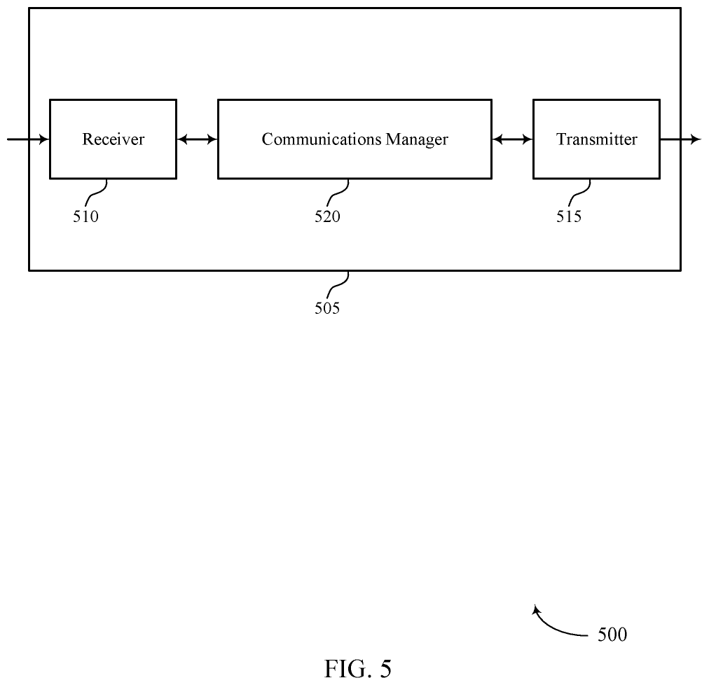

FIG. 5 shows a block diagram 500 of a device 505 that supports transmitting a sidelink feedback message according to a sidelink slot structure in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to transmitting a sidelink feedback message according to a sidelink slot structure). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to transmitting a sidelink feedback message according to a sidelink slot structure). In some examples, the transmitter 515 may be co-located with a receiver 510 in a transceiver unit. The transmitter 515 may utilize a single antenna or a set of multiple antennas.

The communications manager 520, the receiver 510, the transmitter 515, or various combinations thereof or various components thereof may be examples of means for performing various aspects of transmitting a sidelink feedback message according to a sidelink slot structure as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for participating in sidelink communication in accordance with a sidelink slot structure used in a wireless network, where the sidelink slot structure includes a set of periodic AGC candidate TTIs that are common across the wireless network. The communications manager 520 is capable of, configured to, or operable to support a means for monitoring for a sidelink message during a monitoring interval associated with the set of common and periodic AGC candidate TTIs in the sidelink slot structure. The communications manager 520 is capable of, configured to, or operable to support a means for transmitting a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for transmitting a sidelink feedback message according to a particular sidelink slot structure, which may result in improved multiplexing capacity, improved signaling throughput, a more efficient utilization of communication resources, and improved communications between UEs.

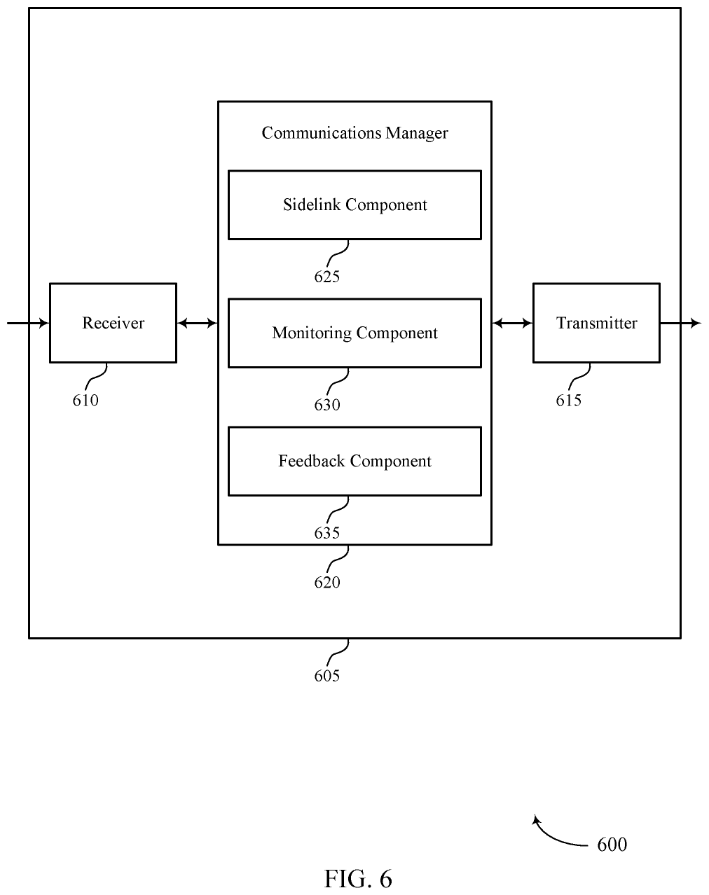

FIG. 6 shows a block diagram 600 of a device 605 that supports transmitting a sidelink feedback message according to a sidelink slot structure in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to transmitting a sidelink feedback message according to a sidelink slot structure). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to transmitting a sidelink feedback message according to a sidelink slot structure). In some examples, the transmitter 615 may be co-located with a receiver 610 in a transceiver unit. The transmitter 615 may utilize a single antenna or a set of multiple antennas.

The device 605, or various components thereof, may be an example of means for performing various aspects of transmitting a sidelink feedback message according to a sidelink slot structure as described herein. For example, the communications manager 620 may include a sidelink component 625, a monitoring component 630, a feedback component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The sidelink component 625 is capable of, configured to, or operable to support a means for participating in sidelink communication in accordance with a sidelink slot structure used in a wireless network, where the sidelink slot structure includes a set of periodic AGC candidate TTIs that are common across the wireless network. The monitoring component 630 is capable of, configured to, or operable to support a means for monitoring for a sidelink message during a monitoring interval associated with the set of common and periodic AGC candidate TTIs in the sidelink slot structure. The feedback component 635 is capable of, configured to, or operable to support a means for transmitting a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

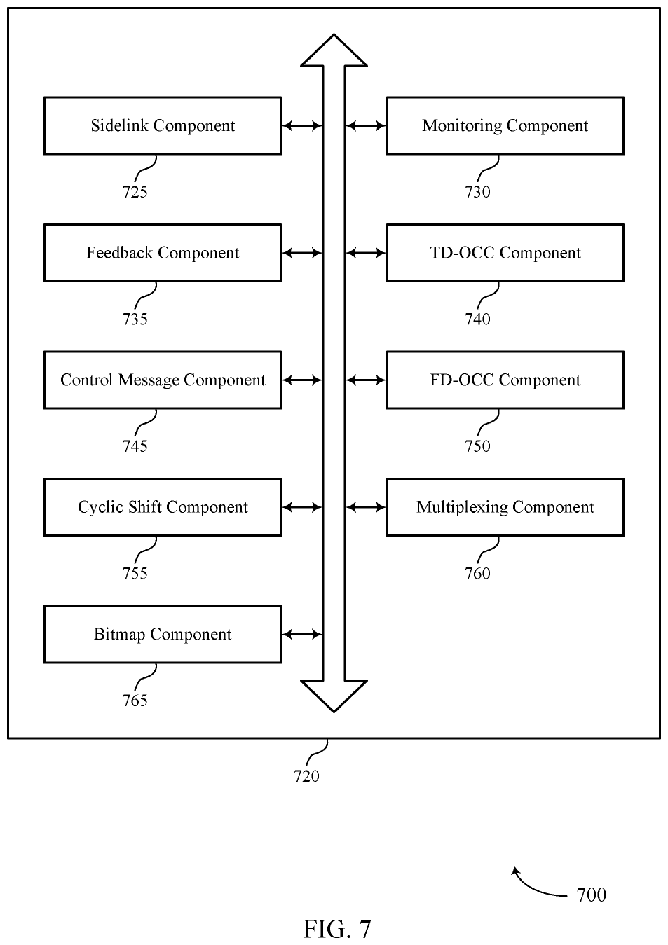

FIG. 7 shows a block diagram 700 of a communications manager 720 that supports transmitting a sidelink feedback message according to a sidelink slot structure in accordance with one or more aspects of the present disclosure. The communications manager 720 may be an example of aspects of a communications manager 520, a communications manager 620, or both, as described herein. The communications manager 720, or various components thereof, may be an example of means for performing various aspects of transmitting a sidelink feedback message according to a sidelink slot structure as described herein. For example, the communications manager 720 may include a sidelink component 725, a monitoring component 730, a feedback component 735, a TD-OCC component 740, a control message component 745, an FD-OCC component 750, a cyclic shift component 755, a multiplexing component 760, a bitmap component 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The sidelink component 725 is capable of, configured to, or operable to support a means for participating in sidelink communication in accordance with a sidelink slot structure used in a wireless network, where the sidelink slot structure includes a set of periodic AGC candidate TTIs that are common across the wireless network. The monitoring component 730 is capable of. configured to, or operable to support a means for monitoring for a sidelink message during a monitoring interval associated with the set of common and periodic AGC candidate TTIs in the sidelink slot structure. The feedback component 735 is capable of, configured to, or operable to support a means for transmitting a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

In some examples, to support transmitting the sidelink feedback message, the feedback component 735 is capable of, configured to, or operable to support a means for transmitting the sidelink feedback message over the set of multiple RBs through transmission of a set of multiple repetitions of the sidelink feedback message.

In some examples, to support transmitting the sidelink feedback message over the set of multiple RBs, the cyclic shift component 755 is capable of, configured to, or operable to support a means for applying a cyclic shift offset for each respective RB of the set of multiple RBs.

In some examples, to support transmitting the sidelink feedback message, the feedback component 735 is capable of, configured to, or operable to support a means for transmitting the sidelink feedback message over the set of multiple RBs through transmission of a sequence whose length is associated with a quantity of the set of multiple RBs. In some examples, a length of a type of the sequence is associated with the length of the sequence.

In some examples, to support transmitting the sidelink feedback message, the feedback component 735 is capable of, configured to, or operable to support a means for transmitting the sidelink feedback message over the set of multiple RBs through transmission of one or more repetitions of the sidelink feedback message over the set of multiple RBs and over multiple symbols. In some examples, to support transmitting the sidelink feedback message, the TD-OCC component 740 is capable of, configured to, or operable to support a means for applying a TD-OCC to the transmission of the one or more repetitions of the sidelink feedback message in accordance with a quantity of the set of multiple RBs exceeding a threshold.

In some examples, the multiplexing component 760 is capable of, configured to, or operable to support a means for multiplexing the sidelink feedback message with additional sidelink feedback messages in accordance with application of the TD-OCC.

In some examples, the control message component 745 is capable of, configured to, or operable to support a means for receiving a control message in advance of transmission of the sidelink feedback message over the set of multiple RBs, where the control message indicates, on a per resource pool basis, a quantity of the set of multiple RBs and a starting RB of the set of multiple RBs over which the transmission of the sidelink feedback message is to start. In some examples, the control message indicates a frequency grid corresponding to the set of multiple RBs.

In some examples, to support receiving the control message, the bitmap component 765 is capable of, configured to, or operable to support a means for receiving a bitmap that indicates the set of multiple RBs, where each bit of the bitmap indicates a corresponding RB of the set of multiple RBs.

In some examples, to support transmitting the sidelink feedback message, the feedback component 735 is capable of, configured to, or operable to support a means for transmitting the sidelink feedback message over the more than two symbols through application of a mapping of the more than two symbols to a quantity of RBs of the sidelink slot structure. In some examples, to support transmitting the sidelink feedback message, the FD-OCC component 750 is capable of, configured to, or operable to support a means for applying a FD-OCC to transmission of the sidelink feedback message over the more than two symbols of the sidelink slot structure.

In some examples, to support transmitting the sidelink feedback message, the feedback component 735 is capable of, configured to, or operable to support a means for transmitting the sidelink feedback message over the more than two symbols through repetition of the sidelink feedback message on a per quantity of symbol basis. In some examples, to support transmitting the sidelink feedback message, the TD-OCC component 740 is capable of, configured to, or operable to support a means for applying a TD-OCC to the repetition of the sidelink feedback message.

In some examples, the multiplexing component 760 is capable of, configured to, or operable to support a means for multiplexing the repetition of the sidelink feedback message in accordance with CDM, where the CDM is associated with an order of a FD-OCC applied to the repetition of the sidelink feedback message and an order of the TD-OCC applied to the repetition of the sidelink feedback message.

In some examples, the set of multiple RBs or the more than two symbols occur after an AGC candidate TTI of the set of periodic AGC candidate TTIs in the sidelink slot structure.

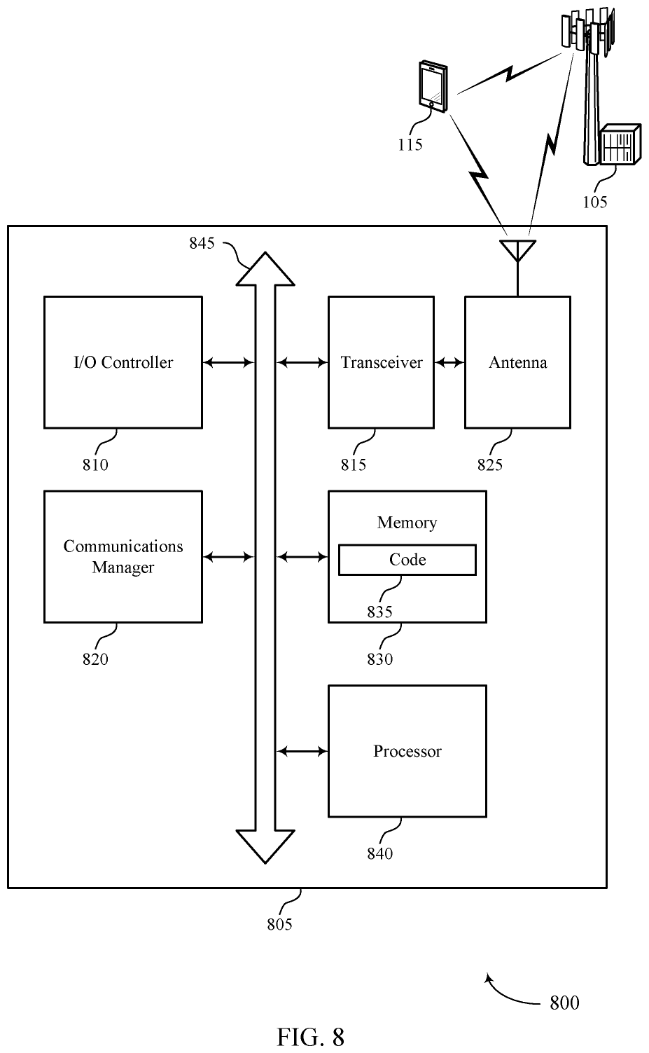

FIG. 8 shows a diagram of a system 800 including a device 805 that supports transmitting a sidelink feedback message according to a sidelink slot structure in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting transmitting a sidelink feedback message according to a sidelink slot structure). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communications in accordance with examples as disclosed herein. For example, the communications manager 820 is capable of, configured to, or operable to support a means for participating in sidelink communication in accordance with a sidelink slot structure used in a wireless network, where the sidelink slot structure includes a set of periodic AGC candidate TTIs that are common across the wireless network. The communications manager 820 is capable of, configured to, or operable to support a means for monitoring for a sidelink message during a monitoring interval associated with the set of common and periodic AGC candidate TTIs in the sidelink slot structure. The communications manager 820 is capable of, configured to, or operable to support a means for transmitting a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure.

By including or configuring the communications manager 820 in accordance with examples as described herein, the device 805 may support techniques for transmitting a sidelink feedback message according to a particular sidelink slot structure, which may result in improved multiplexing capacity, improved signaling throughput, a more efficient utilization of communication resources, and improved communications between UEs.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of transmitting a sidelink feedback message according to a sidelink slot structure as described herein, or the at least one processor 840 and the at least one memory 830 may be otherwise configured to, individually or collectively, perform or support such operations.

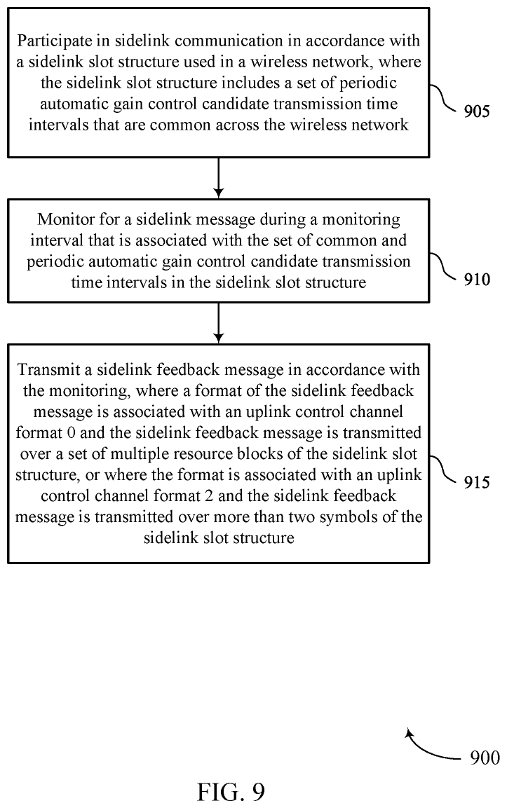

FIG. 9 shows a flowchart illustrating a method 900 that supports transmitting a sidelink feedback message according to a sidelink slot structure in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include participating in sidelink communication in accordance with a sidelink slot structure used in a wireless network, where the sidelink slot structure includes a set of periodic AGC candidate TTIs that are common across the wireless network. The operations of 905 may be performed in accordance with examples as disclosed herein. In some examples, aspects of the operations of 905 may be performed by a sidelink component 725 as described with reference to FIG. 7.

At 910, the method may include monitoring for a sidelink message during a monitoring interval associated with the set of common and periodic AGC candidate TTIs in the sidelink slot structure. The operations of 910 may be performed in accordance with examples as disclosed herein. In some examples, aspects of the operations of 910 may be performed by a monitoring component 730 as described with reference to FIG. 7.

At 915, the method may include transmitting a sidelink feedback message in accordance with the monitoring, where a format of the sidelink feedback message is associated with an uplink control channel format 0 and the sidelink feedback message is transmitted over a set of multiple RBs of the sidelink slot structure, or where the format is associated with an uplink control channel format 2 and the sidelink feedback message is transmitted over more than two symbols of the sidelink slot structure. The operations of 915 may be performed in accordance with examples as disclosed herein. In some examples, aspects of the operations of 915 may be performed by a feedback component 735 as described with reference to FIG. 7.

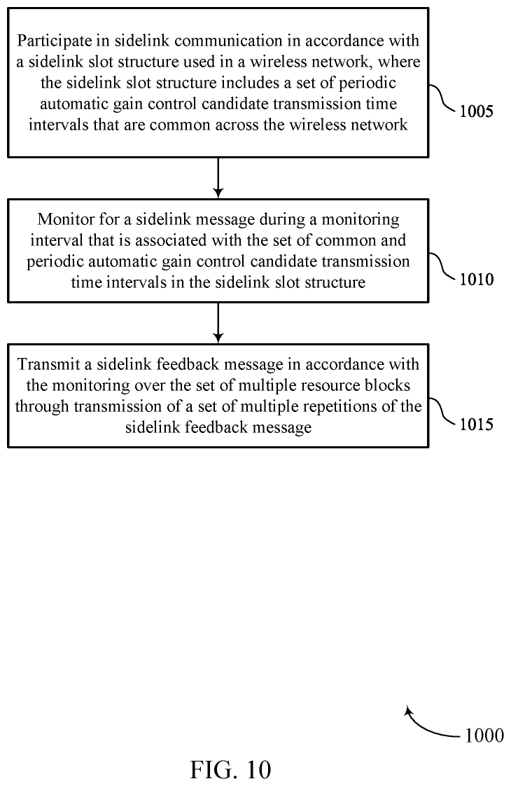

FIG. 10 shows a flowchart illustrating a method 1000 that supports transmitting a sidelink feedback message according to a sidelink slot structure in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include participating in sidelink communication in accordance with a sidelink slot structure used in a wireless network, where the sidelink slot structure includes a set of periodic AGC candidate TTIs that are common across the wireless network. The operations of 1005 may be performed in accordance with examples as disclosed herein. In some examples, aspects of the operations of 1005 may be performed by a sidelink component 725 as described with reference to FIG. 7.

At 1010, the method may include monitoring for a sidelink message during a monitoring interval associated with the set of common and periodic AGC candidate TTIs in the sidelink slot structure. The operations of 1010 may be performed in accordance with examples as disclosed herein. In some examples, aspects of the operations of 1010 may be performed by a monitoring component 730 as described with reference to FIG. 7.

At 1015, the method may include transmitting a sidelink feedback message in accordance with the monitoring over the set of multiple RBs through transmission of a set of multiple repetitions of the sidelink feedback message. The operations of 1015 may be performed in accordance with examples as disclosed herein. In some examples, aspects of the operations of 1015 may be performed by a feedback component 735 as described with reference to FIG. 7.

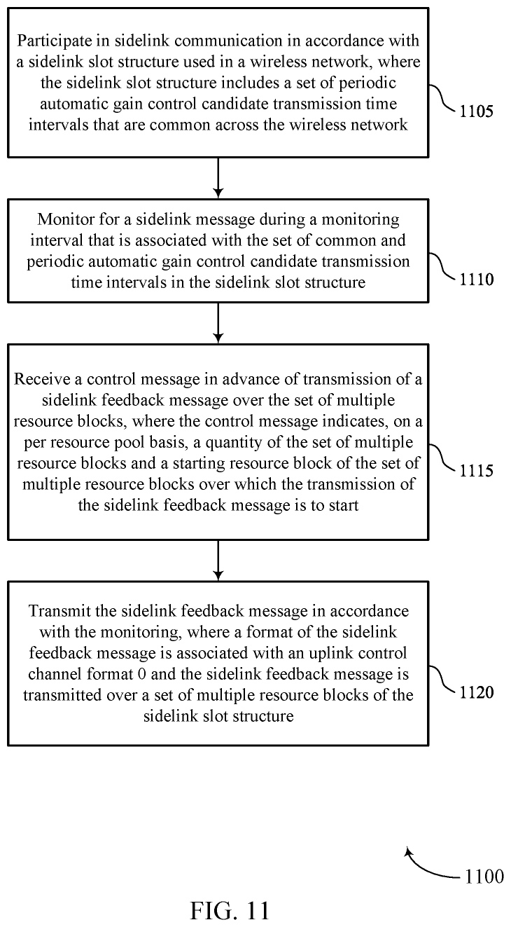

FIG. 11 shows a flowchart illustrating a method 1100 that supports transmitting a sidelink feedback message according to a sidelink slot structure in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include participating in sidelink communication in accordance with a sidelink slot structure used in a wireless network, where the sidelink slot structure includes a set of periodic AGC candidate TTIs that are common across the wireless network. The operations of 1105 may be performed in accordance with examples as disclosed herein. In some examples, aspects of the operations of 1105 may be performed by a sidelink component 725 as described with reference to FIG. 7.

At 1110, the method may include monitoring for a sidelink message during a monitoring interval associated with the set of common and periodic AGC candidate TTIs in the sidelink slot structure. The operations of 1110 may be performed in accordance with examples as disclosed herein. In some examples, aspects of the operations of 1110 may be performed by a monitoring component 730 as described with reference to FIG. 7.

At 1115, the method may include receiving a control message in advance of transmission of a sidelink feedback message over the set of multiple RBs, where the control message indicates, on a per resource pool basis, a quantity of the set of multiple RBs and a starting RB of the set of multiple RBs over which the transmission of the sidelink feedback message is to start. The operations of 1115 may be performed in accordance with examples as disclosed herein. In some examples, aspects of the operations of 1115 may be performed by a control message component 745 as described with reference to FIG. 7.

At 1120, the method may include transmitting the sidelink feedback message in accordance with the monitoring, where a format of the sidelink feedback message is associated with an uplink control channel format 0 and the sidelink feedback message is transmitted over a set of multiple RBs of the sidelink slot structure. The operations of 1120 may be performed in accordance with examples as disclosed herein. In some examples, aspects of the operations of 1120 may be performed by a feedback component 735 as described with reference to FIG. 7.

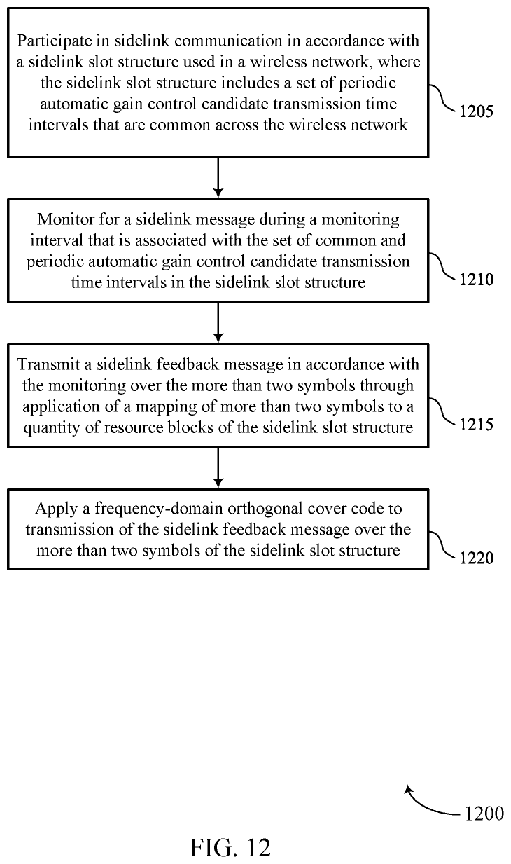

FIG. 12 shows a flowchart illustrating a method 1200 that supports transmitting a sidelink feedback message according to a sidelink slot structure in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include participating in sidelink communication in accordance with a sidelink slot structure used in a wireless network, where the sidelink slot structure includes a set of periodic AGC candidate TTIs that are common across the wireless network. The operations of 1205 may be performed in accordance with examples as disclosed herein. In some examples, aspects of the operations of 1205 may be performed by a sidelink component 725 as described with reference to FIG. 7.

At 1210, the method may include monitoring for a sidelink message during a monitoring interval associated with the set of common and periodic AGC candidate TTIs in the sidelink slot structure. The operations of 1210 may be performed in accordance with examples as disclosed herein. In some examples, aspects of the operations of 1210 may be performed by a monitoring component 730 as described with reference to FIG. 7.

At 1215, the method may include transmitting a sidelink feedback message in accordance with the monitoring over the more than two symbols through application of a mapping of more than two symbols to a quantity of RBs of the sidelink slot structure. The operations of 1215 may be performed in accordance with examples as disclosed herein. In some examples, aspects of the operations of 1215 may be performed by a feedback component 735 as described with reference to FIG. 7.

At 1220, the method may include applying a FD-OCC to transmission of the sidelink feedback message over the more than two symbols of the sidelink slot structure. The operations of 1220 may be performed in accordance with examples as disclosed herein. In some examples, aspects of the operations of 1220 may be performed by an FD-OCC component 750 as described with reference to FIG. 7.

The following provides an overview of aspects of the present disclosure:

Aspect 1: A method for wireless communications at a UE, comprising: participating in sidelink communication in accordance with a sidelink slot structure used in a wireless network, wherein the sidelink slot structure includes a set of periodic AGC candidate TTIs that are common across the wireless network; monitoring for a sidelink message during a monitoring interval associated with the set of common and periodic AGC candidate TTIs in the sidelink slot structure; and transmitting a sidelink feedback message in accordance with the monitoring, wherein a format of the sidelink feedback message is associated with an uplink control channel format 0 and the sidelink feedback message is transmitted over a plurality of RBs of the sidelink slot structure, or wherein the format is associated with an uplink control channel format 2 and the sidelink feedback message is transmitted over more than two symbols of the sidelink slot structure.

Aspect 2: The method of aspect 1, wherein transmitting the sidelink feedback message comprises: transmitting the sidelink feedback message over the plurality of RBs through transmission of a plurality of repetitions of the sidelink feedback message.

Aspect 3: The method of aspect 2, wherein transmitting the sidelink feedback message over the plurality of RBs comprises: applying a cyclic shift offset for each respective RB of the plurality of RBs.

Aspect 4: The method of any of aspects 1 through 3, wherein transmitting the sidelink feedback message comprises: transmitting the sidelink feedback message over the plurality of RBs through transmission of a sequence whose length is associated with a quantity of the plurality of RBs.

Aspect 5: The method of aspect 4, wherein a length of a type of the sequence is associated with the length of the sequence.

Aspect 6: The method of any of aspects 1 through 5, wherein transmitting the sidelink feedback message comprises: transmitting the sidelink feedback message over the plurality of RBs through transmission of one or more repetitions of the sidelink feedback message over the plurality of RBs and over multiple symbols; and applying a TD-OCC to the transmission of the one or more repetitions of the sidelink feedback message in accordance with a quantity of the plurality of RBs exceeding a threshold.

Aspect 7: The method of aspect 6, further comprising: multiplexing the sidelink feedback message with additional sidelink feedback messages in accordance with application of the TD-OCC.

Aspect 8: The method of any of aspects 1 through 7, further comprising: receiving a control message in advance of transmission of the sidelink feedback message over the plurality of RBs, wherein the control message indicates, on a per resource pool basis, a quantity of the plurality of RBs and a starting RB of the plurality of RBs over which the transmission of the sidelink feedback message is to start.

Aspect 9: The method of aspect 8, wherein the control message indicates a frequency grid corresponding to the plurality of RBs.

Aspect 10: The method of any of aspects 8 through 9, wherein receiving the control message comprises: receiving a bitmap that indicates the plurality of RBs, wherein each bit of the bitmap indicates a corresponding RB of the plurality of RBs.

Aspect 11: The method of any of aspects 1 through 10, wherein transmitting the sidelink feedback message comprises: transmitting the sidelink feedback message over the more than two symbols through application of a mapping of the more than two symbols to a quantity of RBs of the sidelink slot structure; and applying a FD-OCC to transmission of the sidelink feedback message over the more than two symbols of the sidelink slot structure.

Aspect 12: The method of any of aspects 1 through 11, wherein transmitting the sidelink feedback message comprises: transmitting the sidelink feedback message over the more than two symbols through repetition of the sidelink feedback message on a per quantity of symbol basis; and applying a TD-OCC to the repetition of the sidelink feedback message.

Aspect 13: The method of aspect 12, further comprising: multiplexing the repetition of the sidelink feedback message in accordance with CDM, wherein the CDM is associated with an order of a FD-OCC applied to the repetition of the sidelink feedback message and an order of the TD-OCC applied to the repetition of the sidelink feedback message.

Aspect 14: The method of any of aspects 1 through 13, wherein the plurality of RBs or the more than two symbols occur after an AGC candidate TTI of the set of periodic AGC candidate TTIs in the sidelink slot structure.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
participate in sidelink communication in accordance with a sidelink slot structure used in a wireless network, wherein the sidelink slot structure includes a set of periodic automatic gain control candidate transmission time intervals that are common across the wireless network;
monitor for a sidelink message during a monitoring interval associated with the set of common and periodic automatic gain control candidate transmission time intervals in the sidelink slot structure; and
transmit a sidelink feedback message in accordance with the monitoring, wherein a format of the sidelink feedback message is associated with an uplink control channel format 0 and the sidelink feedback message is transmitted over a plurality of resource blocks of the sidelink slot structure, or wherein the format is associated with an uplink control channel format 2 and the sidelink feedback message is transmitted over more than two symbols of the sidelink slot structure.

2. The UE of claim 1, wherein, to transmit the sidelink feedback message, the one or more processors are individually or collectively operable to execute the code to cause the UE to:
transmit the sidelink feedback message over the plurality of resource blocks through transmission of a plurality of repetitions of the sidelink feedback message.

3. The UE of claim 2, wherein, to transmit the sidelink feedback message over the plurality of resource blocks, the one or more processors are individually or collectively operable to execute the code to cause the UE to:
apply a cyclic shift offset for each respective resource block of the plurality of resource blocks.

4. The UE of claim 1, wherein, to transmit the sidelink feedback message, the one or more processors are individually or collectively operable to execute the code to cause the UE to:
transmit the sidelink feedback message over the plurality of resource blocks through transmission of a sequence whose length is associated with a quantity of the plurality of resource blocks.

5. The UE of claim 4, wherein a length of a type of the sequence is associated with the length of the sequence.

6. The UE of claim 1, wherein, to transmit the sidelink feedback message, the one or more processors are individually or collectively operable to execute the code to cause the UE to:
transmit the sidelink feedback message over the plurality of resource blocks through transmission of one or more repetitions of the sidelink feedback message over the plurality of resource blocks and over multiple symbols; and
apply a time-domain orthogonal cover code to the transmission of the one or more repetitions of the sidelink feedback message in accordance with a quantity of the plurality of resource blocks exceeding a threshold.

7. The UE of claim 6, wherein the one or more processors are individually or collectively further operable to execute the code to cause the UE to:
multiplex the sidelink feedback message with additional sidelink feedback messages in accordance with application of the time-domain orthogonal cover code.

8. The UE of claim 1, wherein the one or more processors are individually or collectively further operable to execute the code to cause the UE to:
receive a control message in advance of transmission of the sidelink feedback message over the plurality of resource blocks, wherein the control message indicates, on a per resource pool basis, a quantity of the plurality of resource blocks and a starting resource block of the plurality of resource blocks over which the transmission of the sidelink feedback message is to start.

9. The UE of claim 8, wherein the control message indicates a frequency grid corresponding to the plurality of resource blocks.

10. The UE of claim 8, wherein, to receive the control message, the one or more processors are individually or collectively operable to execute the code to cause the UE to:
receive a bitmap that indicates the plurality of resource blocks, wherein each bit of the bitmap indicates a corresponding resource block of the plurality of resource blocks.

11. The UE of claim 1, wherein, to transmit the sidelink feedback message, the one or more processors are individually or collectively operable to execute the code to cause the UE to:
transmit the sidelink feedback message over the more than two symbols through application of a mapping of the more than two symbols to a quantity of resource blocks of the sidelink slot structure; and
apply a frequency-domain orthogonal cover code to transmission of the sidelink feedback message over the more than two symbols of the sidelink slot structure.

12. The UE of claim 1, wherein, to transmit the sidelink feedback message, the one or more processors are individually or collectively operable to execute the code to cause the UE to:
transmit the sidelink feedback message over the more than two symbols through repetition of the sidelink feedback message on a per quantity of symbol basis; and
apply a time-domain orthogonal cover code to the repetition of the sidelink feedback message.

13. The UE of claim 12, wherein the one or more processors are individually or collectively further operable to execute the code to cause the UE to:
multiplex the repetition of the sidelink feedback message in accordance with code division multiplexing, wherein the code division multiplexing is associated with an order of a frequency-domain orthogonal cover code applied to the repetition of the sidelink feedback message and an order of the time-domain orthogonal cover code applied to the repetition of the sidelink feedback message.

14. The UE of claim 1, wherein the plurality of resource blocks or the more than two symbols occur after an automatic gain control candidate transmission time interval of the set of periodic automatic gain control candidate transmission time intervals in the sidelink slot structure.

15. A method for wireless communications at a user equipment (UE), comprising:
participating in sidelink communication in accordance with a sidelink slot structure used in a wireless network, wherein the sidelink slot structure includes a set of periodic automatic gain control candidate transmission time intervals that are common across the wireless network;
monitoring for a sidelink message during a monitoring interval associated with the set of common and periodic automatic gain control candidate transmission time intervals in the sidelink slot structure; and
transmitting a sidelink feedback message in accordance with the monitoring, wherein a format of the sidelink feedback message is associated with an uplink control channel format 0 and the sidelink feedback message is transmitted over a plurality of resource blocks of the sidelink slot structure, or wherein the format is associated with an uplink control channel format 2 and the sidelink feedback message is transmitted over more than two symbols of the sidelink slot structure.

16. The method of claim 15, wherein transmitting the sidelink feedback message comprises:
transmitting the sidelink feedback message over the plurality of resource blocks through transmission of a plurality of repetitions of the sidelink feedback message.

17. The method of claim 16, wherein transmitting the sidelink feedback message over the plurality of resource blocks comprises:
applying a cyclic shift offset for each respective resource block of the plurality of resource blocks.

18. The method of claim 15, wherein transmitting the sidelink feedback message comprises:
transmitting the sidelink feedback message over the plurality of resource blocks through transmission of a sequence whose length is associated with a quantity of the plurality of resource blocks.

19. The method of claim 18, wherein a length of a type of the sequence is associated with the length of the sequence.

20. The method of claim 15, wherein transmitting the sidelink feedback message comprises:
transmitting the sidelink feedback message over the plurality of resource blocks through transmission of one or more repetitions of the sidelink feedback message over the plurality of resource blocks and over multiple symbols; and
applying a time-domain orthogonal cover code to the transmission of the one or more repetitions of the sidelink feedback message in accordance with a quantity of the plurality of resource blocks exceeding a threshold.

21. The method of claim 20, further comprising:
multiplexing the sidelink feedback message with additional sidelink feedback messages in accordance with application of the time-domain orthogonal cover code.

22. The method of claim 15, further comprising:
receiving a control message in advance of transmission of the sidelink feedback message over the plurality of resource blocks, wherein the control message indicates, on a per resource pool basis, a quantity of the plurality of resource blocks and a starting resource block of the plurality of resource blocks over which the transmission of the sidelink feedback message is to start.

23. The method of claim 22, wherein the control message indicates a frequency grid corresponding to the plurality of resource blocks.

24. The method of claim 22, wherein receiving the control message comprises:
receiving a bitmap that indicates the plurality of resource blocks, wherein each bit of the bitmap indicates a corresponding resource block of the plurality of resource blocks.

25. The method of claim 15, wherein transmitting the sidelink feedback message comprises:
transmitting the sidelink feedback message over the more than two symbols through application of a mapping of the more than two symbols to a quantity of resource blocks of the sidelink slot structure; and
applying a frequency-domain orthogonal cover code to transmission of the sidelink feedback message over the more than two symbols of the sidelink slot structure.

26. The method of claim 15, wherein transmitting the sidelink feedback message comprises:
transmitting the sidelink feedback message over the more than two symbols through repetition of the sidelink feedback message on a per quantity of symbol basis; and
applying a time-domain orthogonal cover code to the repetition of the sidelink feedback message.

27. The method of claim 26, further comprising:
multiplexing the repetition of the sidelink feedback message in accordance with code division multiplexing, wherein the code division multiplexing is associated with an order of a frequency-domain orthogonal cover code applied to the repetition of the sidelink feedback message and an order of the time-domain orthogonal cover code applied to the repetition of the sidelink feedback message.

28. The method of claim 15, wherein the plurality of resource blocks or the more than two symbols occur after an automatic gain control candidate transmission time interval of the set of periodic automatic gain control candidate transmission time intervals in the sidelink slot structure.

29. A user equipment (UE) for wireless communications, comprising:
means for participating in sidelink communication in accordance with a sidelink slot structure used in a wireless network, wherein the sidelink slot structure includes a set of periodic automatic gain control candidate transmission time intervals that are common across the wireless network;
means for monitoring for a sidelink message during a monitoring interval associated with the set of common and periodic automatic gain control candidate transmission time intervals in the sidelink slot structure; and
means for transmitting a sidelink feedback message in accordance with the monitoring, wherein a format of the sidelink feedback message is associated with an uplink control channel format 0 and the sidelink feedback message is transmitted over a plurality of resource blocks of the sidelink slot structure, or wherein the format is associated with an uplink control channel format 2 and the sidelink feedback message is transmitted over more than two symbols of the sidelink slot structure.

30. A non-transitory computer-readable medium storing code for wireless communications, the code comprising instructions executable by one or more processors to:
participate in sidelink communication in accordance with a sidelink slot structure used in a wireless network, wherein the sidelink slot structure includes a set of periodic automatic gain control candidate transmission time intervals that are common across the wireless network;
monitor for a sidelink message during a monitoring interval associated with the set of common and periodic automatic gain control candidate transmission time intervals in the sidelink slot structure; and
transmit a sidelink feedback message in accordance with the monitoring, wherein a format of the sidelink feedback message is associated with an uplink control channel format 0 and the sidelink feedback message is transmitted over a plurality of resource blocks of the sidelink slot structure, or wherein the format is associated with an uplink control channel format 2 and the sidelink feedback message is transmitted over more than two symbols of the sidelink slot structure.
